(19) United States
(12) Patent Application Publication
(10) Pub. No.: US 2011/0019136 A1
(43) Pub. Date: Jan. 27, 2011

(54) LIQUID CRYSTAL DISPLAY DEVICE

(76) Inventors: Katsuya Ogawa, Osaka (JP); Kazuyoshi Fujioka, Osaka (JP)

Correspondence Address: NIXON & VANDERHYE, PC, 901 NORTH GLEBE ROAD, 11TH FLOOR, ARLINGTON, VA, 22203, US

(21) Appl. No.: 12/921,237

(22) PCT Filed: Nov. 17, 2008
(86) PCT No.: PCT/JP2008/070876

§ 371 Date: Sep. 7, 2010

(51) Int. Cl. G02F 1/1335

(52) U.S. Cl. 349/113

(57) ABSTRACT

The present invention provides a liquid crystal display device capable of providing improved display characteristics in each of transmissive display and reflection display while suppressing an increase in costs and a module thickness. The present invention is a liquid crystal display device, comprising:
a back-side substrate;
a viewing-side substrate facing the back-side substrate;
a liquid crystal layer disposed between the back-side substrate and the viewing-side substrate;
a reflection region; and
a transmission region,
the viewing-side substrate including:
a reflective-portion retardation layer in the reflection region, not in the transmission region; and
a light-shielding member that is disposed at a boundary between the reflection region and the transmission region when the viewing-side substrate is viewed in plan.

### TECHNICAL FIELD

The present invention relates to a liquid crystal display device. More particularly, the present invention relates to a liquid crystal display device including a reflection region and a transmission region.

### BACKGROUND ART

Liquid crystal display (LCD) devices are widely used in electronic apparatuses such as a monitor, a projector, a mobile phone, and a personal digital assistant (PDA) by utilizing characteristics of the LCD devices such as low-profile, lightweight, and low-power-consumption characteristics. As such LCD devices, transmission type LCD devices, reflection LCD devices, transflective type LCD devices (reflection-transmission type LCD devices), and the like are known. Transmissive type LCD devices perform display by using light emitted from the back side, such as light from a backlight that is provided on the back side of an LCD panel. The light is introduced into the LCD panel from the back side and emitted. Reflective type LCD devices perform display by using light incident from the front side (viewing side) such as ambient light and light from a frontlight. The light is introduced into an LCD panel from the front side and reflected. Transflective LCD type devices perform transmissive display by using light from the back side in relatively dark environments such as indoor environments, and perform reflection display by using light from the front side in relatively bright environments such as outdoor environments. That is, the transflective type LCD devices have a feature of reflection type LCD devices in which excellent visibility is provided in bright environments and a feature of transmission type LCD devices in which excellent visibility is provided in dark environments.

Conventional transflective type LCD devices include a back-side substrate, a viewing-side substrate facing the back-side substrate, and a liquid crystal (LC) layer disposed between the back-side substrate and, the viewing-side substrate. The back-side substrate includes a quarter wave layer and a polarizer stacked in this order on a side opposite to an LC-layer side of the substrate. The viewing-side substrate includes a quarter wave layer and a polarizer stacked in this order on a side opposite to an LC-layer side of the substrate. Thus, the conventional transflective type LCD devices have at least one retardation layer on each front side and back side thereof, that is, at least two retardation layers in total.

As mentioned above, a quarter wave layer for reflection display is arranged on the entire exterior surface (a surface opposite to a surface facing an LC layer) (both a transmission region and a reflection region) of a viewing-side substrate and a back-side substrate in the conventional transflective type LCD devices. However, in such a configuration of the transflective type LCD devices, a quarter wave layer originally unneeded for transmissive display is arranged in the transmission region, and therefore contrast characteristics in transmissive display are easily deteriorated as compared to that of transmission type LCD devices. Further, the number of the retardation layers included in the transflective type LCD devices is larger than that included in reflection type LCD devices or transmission type LCD devices, which leads to an increase in costs and the thickness of a module (module thickness). In such respects, the transflective type LCD devices have room for improvement.

For such problems, Patent Document 1 discloses, for example, LCD devices having a pair of substrates, an LCD layer disposed between the pair of substrates, and a reflective part and a transmissive part, as a technology for reducing the number of retardation layers on the back side of a transflective type LCD device. The LCD devices include a retardation layer formed in at least one substrate, and the retardation layer provides retardation different in the reflective part and the transmissive part.

### [Patent Document 1]

Japanese Kokai Publication No. 2003-322857

### DISCLOSURE OF INVENTION

According to the technology described in Patent Document 1, when a viewing-side substrate and a back-side substrate are attached to each other to be misaligned, in transmissive display, part of light that has entered an LC layer from the back side is likely to be transmitted through a retardation layer formed in the viewing-side substrate and emitted, and, in reflection display, part of light that has entered an LC layer from the viewing side is likely to be emitted from the viewing side without passing through a retardation layer. That is, according to the technology described in Patent Document 1, contrast characteristics in transmissive display and the reflection display are likely to be degraded.

The present invention has been made in view of the above-mentioned state of the art, and has an object to provide an LCD device capable of providing improved display characteristic(s) in each of transmissive display and reflection display while suppressing an increase in costs and a module thickness.

The present inventors made various investigations on a LCD device capable of providing improved display characteristic(s) in each of transmissive display and reflection display while suppressing an increase in costs and a module thickness, and noted a technology for forming a retardation layer only in a reflection region. The inventors found that a retardation layer unneeded for transmissive display does not have to be formed and display characteristic(s) in each of transmissive display and reflection display can be improved when a viewing-side substrate includes not only a retardation layer formed in the reflection region, not in a transmission region, but also a light-shielding member formed at a boundary between the reflection region and the transmission region when the viewing-side substrate is viewed in plan. Thus, the above-mentioned problems have been admirably solved, leading to completion of the present invention.

That is, the present invention is a liquid crystal display device, comprising:

a back-side substrate;

a viewing-side substrate facing the back-side substrate;

a liquid crystal layer disposed between the back-side substrate and the viewing-side substrate;

a reflection region; and

a transmission region,

the viewing-side substrate including:

a reflective-portion retardation layer in the reflection region, not in the transmission region; and

a light-shielding member that is disposed at a boundary between the reflection region and the transmission region when the viewing-side substrate is viewed in plan.

The present invention is mentioned below in more detail.

The LCD device of the present invention includes a back-side substrate, a viewing-side substrate facing the back-side substrate, a liquid crystal layer disposed between the back-side substrate and the viewing-side substrate, a reflection region, and a transmission region. The LCD device generally performs display by changes in retardation of an LC layer in each pixel region caused by varying a voltage applied between a pair of pixel electrodes each formed in a pair of substrates or both formed in one of the pair of substrates. As used herein, a “pixel electrode” means an electrode formed for driving liquid crystals. A “transmission region” means a region contributing to transmissive display, and a “reflection region” means a region contributing to reflection display.

Specifically, light used for transmissive display passes through an LC layer in a transmission region, and light used for reflection display passes through an LC layer in a reflection region. According to the present invention, a voltage applied between pixel electrodes is typically substantially equivalent between a transmission region and a reflection region. That is, liquid crystals in the transmission region and liquid crystals in the reflection region are typically driven at the same voltage. If the liquid crystals in the transmission region and the liquid crystals in the reflection region are driven at different voltages, a switching element such as a thin film transistor (TFT) needs to be formed in each region, which may lead to a complicated pixel structure. As a result, an aperture area might be decreased.

The viewing-side substrate includes: a

reflective-portion retardation layer in the reflection region, not in the transmission region; and a light-shielding member that is disposed at a boundary between the reflection region and the transmission region when the viewing-side substrate is viewed in plan. As mentioned above, when the reflective-portion retardation layer is formed in the reflection region, not in the transmission region, of a viewing-side substrate, a retardation layer unneeded for transmissive display does not need to be formed in the transmission region. Therefore, an increase in costs and a module thickness can be suppressed. Further, when a light-shielding member is formed at a boundary between the reflection region and the transmission region of the viewing-side substrate as mentioned above, each light emission inadequate for transmissive display or reflection display can be suppressed. Therefore, the display characteristics of the transmissive display and the reflection display, particularly contrast characteristics thereof can be improved.

The configuration of the LCD device according to the present invention is not especially limited as long as such components are essentially included. The LCD device may or may not include other components.

Preferred embodiments of the LCD device of the present invention are mentioned below in more detail. It should be understood that the following embodiments may be appropriately combined.

The reflective-portion retardation layer of the present invention may be formed on a side opposite to the LC-layer side of the viewing-side substrate, and is preferably formed on the LC-layer side of the viewing-side substrate. Such a reflective-portion retardation layer formed in a cell can suppress deterioration thereof caused by external factors such as ultraviolet rays and humidity.

It is preferred that the viewing-side substrate includes a flattening layer disposed in a region covering at least a display region, the flattening layer being disposed between the reflective-portion retardation layer and the liquid crystal layer. This allows the formation of a flatter surface on an uneven portion of structures (a color filter colorant layer, a black matrix, and the like) formed on the LC-layer side of the viewing-side substrate, thereby suppressing the occurrence of alignment disorder of liquid crystals at the uneven portion. As a result, display quality is less likely to be deteriorated. As used herein, a flattening layer is a film that provides a flatter surface on a surface with unevenness. has a function of flattening (lessening) unevenness. When the surface of the flattening layer has an uneven portion, it is preferred that a radius of curvature of the uneven portion is larger than the height of the unevenness. As a result, a conductive layer (pixel electrode) in an upper layer can be effectively suppressed from being disconnected.

The reflective-portion retardation layer is not particularly limited as long as the layer is an optically anisotropic layer and improves display characteristic(s) of reflection display. Particularly, the reflective-portion retardation layer of the present invention preferably includes a quarter wave layer. Thus the display characteristic(s) of reflection display can be particularly effectively improved.

It is sufficient that the light-shielding member has light-shielding properties comparable to those of a black matrix included in conventional LCD devices, and the light-shielding member does not need to completely shield light (visible light, more specifically light with a wavelength of 380 to 780 nm) It is preferred that the viewing-side substrate of the present invention includes a black matrix at a boundary between pixels, and the light-shielding member is integrally formed with the black matrix. Thus, the light-shielding member can be formed more easily.

Examples of the LCD device of the present invention include, but not limited to, a vertical alignment LCD device and a twisted nematic LCD device. The vertical alignment LCD device which tends to provide high contrast characteristic(s) as compared to those of other LCD devices is preferred because deterioration of the contrast characteristic(s) in transmissive display can be suppressed even in a transflective type LCD device. That is, it is preferred that the liquid crystal layer of the present invention is a vertical alignment liquid crystal layer. The LCD device preferably includes a vertically aligned LC layer. Liquid crystal molecules in the “vertically aligned LC layer” do not need to be aligned completely vertical to a substrate surface. The LC molecules may be aligned approximately (substantially) vertical to the substrate surface and may have a pretilt angle relative to the substrate surface.

### EFFECT OF THE INVENTION

According to the liquid crystal display device of the present invention, display characteristic(s) in each of transmissive display and reflection display can be improved while suppressing an increase in costs and a module thickness.

### BEST MODES FOR CARRYING OUT THE INVENTION

The present invention is mentioned in more detail below with reference to Embodiments using drawings, but not limited thereto.

### EMBODIMENT 1

FIG. 1 is a cross-sectional view schematically showing a configuration of the liquid crystal display device in accordance with Embodiment 1.

A liquid crystal display device 100 in accordance with Embodiment 1 includes a back-side substrate 50, a viewing-side substrate 60 facing the substrate 50, and a liquid crystal layer 70 disposed between the back-side substrate 50 and the viewing-side substrate 60. The LCD device 100 is a transflective type LCD device (a reflection-transmission type LCD device) including transmission regions T and reflection regions R, and capable of performing both transmissive display and reflection display. The transmissive display is performed by using as a light source a backlight 80 formed on the back side of the back-side substrate 50, and the reflection display is performed by using as a light source ambient light and the like that have entered the LC layer 70 from a viewing side.

The back-side substrate 50 includes, on a glass substrate 10, a plurality of gate bus lines; a plurality of storage capacitor (Cs) lines 16 extending in parallel with the gate bus lines; a plurality of source bus lines extending in parallel with each other and perpendicular to the gate bus lines and the storage capacitor lines 16; a thin film transistor (TFT) formed at each intersection of the plurality of gate bus lines and the plurality of source bus lines; and an insulating film 12. The insulating film 12 is disposed between the TFT and the liquid crystal layer 70. The TFT includes a gate electrode, a source electrode, and a drain electrode lid. The gate electrode is connected to the gate bus line, the source electrode is connected to the source bus line, and the drain electrode 11d is electrically connected to a pixel electrode 14 through an aperture formed in the insulating film 12. An alignment film is formed so as to cover the pixel electrode 14. The pixel electrode 14 is formed of a material with a high transparency (e.g., a transparent conductive film such as an ITO). As mentioned above, the LCD device 100 is an active matrix LCD device in which pixels are arranged in a matrix pattern. The region surrounded with the adjacent gate bus lines and the adjacent source bus lines constitutes approximately one pixel region.

The drain electrode 11d and the storage capacitor line 16 are arranged facing each other with a gate insulating film 15 of the TFT therebetween and form a storage capacitor (Cs). The drain electrode lid and the storage capacitor line 16 function also as a reflective film 19 formed of a material (e.g., aluminum and silver) with a high reflection, and shield light emitted from a backlight 80 to protrusions 22 formed on the viewing-side substrate 60 and reflect ambient light from the viewing side. Thereby, reflection display can be performed. For this reason, the drain electrode lid and the storage capacitor line 16 are arranged to face the protrusions 22 and the like. As mentioned above, the LCD device 100 includes the reflective film 19 and the transparent pixel electrode 14. The reflective film 19 is arranged at least in the reflection region R, but not arranged in the transmission regions T. The transparent pixel electrode 14 is arranged in the transmission regions T. A polarizer 17 is attached on the back side of the glass substrate 10.

In the transmission regions T of the viewing-side substrate 60, a colored layer (color filter colorant layer) 27, a flattening layer (overcoat layer) 24, a pixel electrode 21, the protrusions 22, and an alignment film (not shown) are stacked on a glass substrate 20 in this order. In the reflection regions R of the viewing-side substrate 60, a quarter wave layer 25, as a reflective-portion retardation layer, having the same function as what is called a quarter wave plate, the colored layer 27, the flattening layer 24, the pixel electrode 21, the protrusions 22, and the alignment film (not shown) are stacked on the glass substrate 20 in this order. Examples of the colored layer 27 include a red (R) color filter, a green (G) color filter, and a blue (B) color filter, and each of the color filters is arranged to overlap with the pixel electrode 14 (pixel region) of the back-side substrate 50. Further, the viewing-side substrate 60 includes, on the glass substrate 20, a black matrix (BM) 26 that is a light-shielding member formed at a boundary between pixels. As a result, colors of adjacent pixels can be effectively suppressed from being mixed. The BM 26 is formed also at a boundary between the transmission region T and the reflection region R. The BM 26 is formed in a portion linearly formed along the boundary between the pixels so as to partition the pixels and a portion linearly formed along the boundary between the transmission region T and the reflection region R so as to partition the transmission region T and the reflection region R. The BM 26 is formed of a metal such as chromium, or a black resin. The flattening layer 24 is formed of a transparent resin, and is formed over the entire display region including the transmission regions T and the reflection regions R so as to cover the BM 26, the quarter wave layer 25, and the colored layer 27, and therefore a flatter surface is formed over unevenness due to the BM 26, the quarter wave layer, and the colored layer 27. The pixel electrode 21 is formed as a seamless electrode (common electrode) so as to cover the entire display region. The pixel electrode 21 is formed of a material with a high transparency (e.g., a transparent conductive film, such as an ITO). The protrusions 22 for controlling alignment of liquid crystals in the LC layer 70 is formed on the pixel electrode 21. The protrusions 22 is formed so as to overlap with the reflective film 19 of the back-side substrate 50. The alignment film is formed over the entire display region so as to cover the protrusions 22 and the pixel electrode 21. A polarizer 23 is attached on a viewing-side of the glass substrate 20. An absorption axis of a polarizing element of the polarizer 23 is arranged so as to make an angle of 45° with a slow axis of the quarter wave layer 25 when the viewing-side substrate 60 is viewed in plan.

Examples of the production method of the viewing-side substrate 60 include, but not particularly limited to, the successive steps of: (1) patterning the BM 26, (2) patterning the quarter wave layer 25 for selective formation thereof in the reflection regions R, (3) patterning the colored layer 27, (4) forming the flattening layer 24, (5) forming the pixel electrode 14, (6) patterning the protrusions 22, and (7) forming the alignment film and performing aligning treatment thereon. The reflective-portion retardation layer such as the quarter wave layer 25 may be pattered, for example, by a method in which a liquid crystal monomer is coated on the glass substrate 20 having the BM 26 patterned thereon, the liquid crystal monomer is cured to form a liquid crystal polymer, and the polymer is then patterned only in the reflection region. More specifically, the reflective-portion retardation layer such as the quarter wave layer 25 can be provided in a desired shape by coating a photosensitive liquid crystal polymer on the glass substrate 20 having the BM 26 patterned thereon and performing exposure and development. Further, the reflective-portion retardation layer such as the quarter wave layer 25 may be provided by coating a UV-curable liquid crystal monomer with a nematic phase on the glass substrate 20 having the patterned BM 26, and producing a liquid crystal polymer by UV irradiation. Retardation of the reflective-portion retardation layer is appropriately adjustable by changing the thickness thereof. A material of the reflective-portion retardation layer is not limited to a liquid crystal polymer. The reflective-portion retardation layer may be formed using a stretched film.

The LC layer 70 includes nematic LCs with negative dielectric anisotropy. The LCD device 100 is a vertical alignment (VA) LCD device. Liquid crystals therein are aligned substantially vertically to the surfaces of the alignment films of the back-side substrate 50 and the viewing-side substrate 60, more specifically, aligned to have a pretilt angle of about 85 to 90° (more preferably about 88° to 90°), when no voltage is applied. Liquid crystals are horizontally inclined when a voltage is applied. According to the present Embodiment, a thin aperture (slit) 14a formed in the pixel electrode 14 of the back-side substrate 50 and the protrusions 22 formed along the aperture (slit) 14a in the viewing-side substrate 60 provide a multi-domain. Thereby, disclination due to liquid crystals disorderly inclined downward can be prevented, and display can be uniform when viewed from any direction. The LCD device 100 does not include a multi-gap structure but has an similar cell gap in both the transmission regions T and the reflection regions R. The polarizer 23 and the polarizer 17 are arranged in Cross-Nicol, and therefore the LCD device 100 provides normally black display.

According to the LCD device 100, the quarter wave layer 25 is selectively formed only in the reflection regions R, not in the transmission regions T. Therefore, unlike conventional transflective type LCD devices, a retardation layer (e.g., quarter wave layer) unneeded for transmissive display needs not to be formed outside the back-side substrate 50 and the viewing-side substrate 60. As a result, a reduction in transmissive display performance can be suppressed, and display characteristic(s) of reflection display can be simultaneously effectively improved. Thus, an increase in costs and a module thickness can be suppressed.

The BM 26 is formed as a light-shielding member at a boundary of the reflection region R and the transmission. region T of the viewing-side substrate 60. Such a BM 26 effectively shields inadequate light in each of transmissive display and reflection display even if the viewing-side substrate 60 and the back-side substrate 50 are misaligned when attached to each other in the production process. Therefore, the display characteristic(s) in each of transmissive display and reflection display, particularly the contrast characteristics thereof, can be improved.

The quarter wave layer 25 can be suppressed from being deteriorated by external factors such as ambient light and humidity, because the quarter wave layer 25 is formed on a liquid-crystal-layer-70 side.

Further, occurrence of light leakage due to liquid crystal alignment disorder at an uneven portion can be suppressed because the flattening layer 24 covers unevenness due to the BM 26, the quarter wave layer, and the colored layer 27 so as to form a flatter surface.

A light-shielding member that blocks light through a boundary between the transmission region T and the reflection region R and a light-shielding member that blocks light through a boundary between the pixels can be easily formed because the BM 26 is integrally arranged as the light-shielding members.

The width of a portion of the BM 26 that blocks light through a boundary between the transmission region T and, the reflection region R may be appropriately determined in accordance with positional accuracy of the substrates attached to each other, a layout of pixels, a cell gap, and the like. In order to obtain a high aperture ratio, it is preferred that the width is set as small as possible to the extent that display characteristic(s) transmissive display and reflection display, particularly contrast characteristic(s) therein, are not deteriorated. More specifically, the width of the portion of the BM 26 that blocks light through a boundary between the transmission region T and the reflection region R is preferably about 3 to 5 μm, for example.

The LCD device 100 in accordance with the present Embodiment may have a retardation layer (e.g., a half wave layer) for compensating wavelength dispersion of the quarter wave layer 25, in addition to the quarter wave layer 25, as a reflective-portion retardation layer (a retardation layer formed in the reflection regions R, not in the transmission regions T, that is, a retardation layer selectively formed in the reflection regions R) Therefore, occurrence of light leakage in a black display state can be effectively suppressed. As mentioned above, the reflective-portion retardation layer may be a stack of a plurality of retardation layers.

The reflective-portion retardation layer such as the quarter wave layer 25 maybe arranged at any position in a thickness direction of the viewing-side substrate 60 as long as the reflective-portion retardation layer is arranged between the flattening layer 24 and the glass substrate 20. For example, the quarter wave layer 25 may be formed between the colored layer 27 and the LC layer 70. When the reflective-portion retardation layer includes a plurality of retardation layers, the order of the retardation layers and the colored layer 27 can be appropriately determined.

The LCD device 100 of the present Embodiment further may include, in addition to the reflective-portion retardation layer, a retardation layer that is different from a reflective-portion retardation layer, in the transmission regions T.

The present application claims priority to Patent Application No. 2008-61345 filed in Japan on Mar. 11, 2008 under the Paris Convention and provisions of national law in a designated State, the entire contents of which are hereby incorporated by reference.

### BRIEF DESCRIPTION OF DRAWINGS

FIG. 1 is a cross-sectional view schematically showing a configuration of the liquid crystal display device in accordance with Embodiment 1.

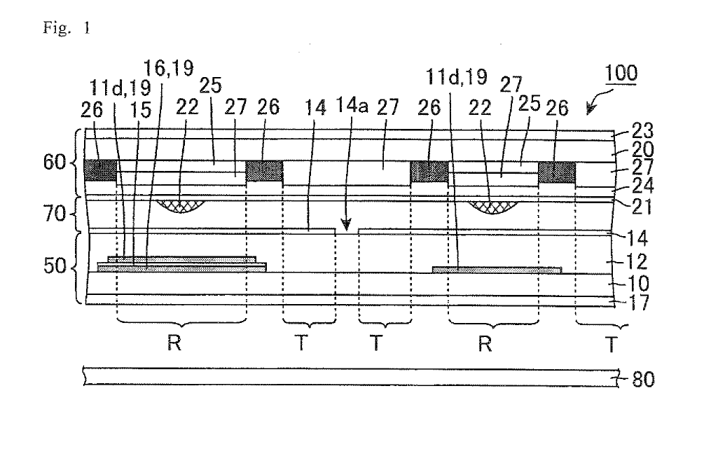

### EXPLANATION OF NUMERALS AND SYMBOLS

10, 20: Glass substrate
11d: Drain electrode
12: Insulating film (Interlayer insulating film)
14: Pixel electrode
14a: Aperture of pixel electrode (Slit)
15: Gate insulating film
16: Storage capacitor line
17, 23: Polarizer
19: Reflective film
21: Pixel electrode (Common electrode)
22: Protrusion (Protrusion for controlling an alignment, Rib)
24: Flattening layer (Overcoat layer)
25: Quarter wave layer (Reflective-portion retardation layer)
26: Black matrix (BM)
27: Colored layer
50: Back-side substrate
60: Viewing-side substrate
70: Liquid crystal layer
80: Backlight
100: Liquid crystal display device
T: Transmission region
R: Reflection region

1. A liquid crystal display device, comprising:
a back-side substrate;
a viewing-side substrate facing the back-side substrate;
a liquid crystal layer disposed between the back-side substrate and the viewing-side substrate;
a reflection region; and
a transmission region,
the viewing-side substrate including:
a reflective-portion retardation layer in the reflection region, not in the transmission region; and
a light-shielding member that is disposed at a boundary between the reflection region and the transmission region when the viewing-side substrate is viewed in plan.

2. The liquid crystal display device according to claim 1,
wherein the reflective-portion retardation layer is disposed on a liquid-crystal-layer side of the viewing-side substrate.

3. The liquid crystal display device according to claim 2,
wherein the viewing-side substrate includes a flattening layer disposed in a region covering at least a display region, the flattening layer being disposed between the reflective-portion retardation layer and the liquid crystal layer.

4. The liquid crystal display device according to claim 1,
wherein the reflective-portion retardation layer includes a quarter wave layer.

5. The liquid crystal display device according to claim 1,
wherein the viewing-side substrate includes a black matrix at a boundary between pixels,
and the light-shielding member is integrally formed with the black matrix.

6. The liquid crystal display device according to claim 1,
wherein the liquid crystal layer is a vertical alignment liquid crystal layer.
